(19) United States
(12) Patent Application Publication
(10) Pub. No.: US 2026/0054953 A1
(43) Pub. Date: Feb. 26, 2026

(54) SHEET EMBELLISHING SYSTEM AND METHOD

(71) Applicant: Duplo Corporation, Sagamihara-shi (JP)

(72) Inventor: Ryo Yamamoto, Sagamihara-shi (JP)

(73) Assignee: Duplo Corporation, Sagamihara-shi (JP)

(21) Appl. No.: 19/230,550

(22) Filed: Jun. 6, 2025

(30) Foreign Application Priority Data
Aug. 20, 2024 (JP) 2024-139241
Nov. 8, 2024 (JP) 2024-196207

(51) Int. Cl. B65H 37/02; B05D 3/06

(52) U.S. Cl. CPC B65H 37/02; B05D 3/067; B05D 2252/00; B65H 2515/60

(57) ABSTRACT

A sheet embellishing system performs embellishment on a sheet while conveying the sheet. The sheet embellishing system includes a varnish-applying unit that applies varnish having ultraviolet (UV) curability onto the sheet, a UV irradiation unit that irradiates the varnish on the sheet by UV rays, and a control device. The control device acquires, from a storage unit that stores adhesivity-related information that is information relating to adhesivity between the varnish on the sheet and a transfer material that is to be transferred into the varnish on the sheet, and a value regarding a control item of the sheet embellishing system, in a correlated manner, a value of the control item of which the adhesivity-related information corresponds to the adhesivity-related information of a current job, and executes predetermined processing using the value of the control item that is acquired.

### BACKGROUND OF THE INVENTION

### 1. Field of the Invention

The present disclosure relates to a sheet embellishing system and a method.

### 2. Description of the Related Art

There is known a sheet embellishing system in which a surface of a sheet is coated with varnish, and transfer processing such as foil stamping or the like onto the varnish applied to the surface of the sheet is performed (see WO 2023/008456, for example).

In the sheet embellishing system, values of control items of the sheet embellishing system that affect total light intensity of ultraviolet (UV) rays by which the varnish is irradiated need to be adjusted, and this adjustment is a burden on the user.

### SUMMARY OF THE INVENTION

The present disclosure has been made in light of the foregoing circumstances, and an exemplary object of an aspect thereof is to provide a sheet embellishing system in which burden on the user is reduced.

In order to solve the above problem, a sheet embellishing system according to an aspect of the present invention is a sheet embellishing system that performs embellishment on a sheet while conveying the sheet, and includes a varnish-applying unit that applies varnish having ultraviolet (UV) curability onto the sheet, a UV irradiation unit that irradiates the varnish on the sheet by UV rays, and a control device. The control device acquires, from a storage unit that stores adhesivity-related information that is information relating to adhesivity between the varnish on the sheet and a transfer material that is to be transferred into the varnish on the sheet, and a value regarding a control item of the sheet embellishing system, in a correlated manner, a value of the control item of which the adhesivity-related information corresponds to the adhesivity-related information of a current job, and executes predetermined processing using the value of the control item that is acquired.

It should be noted that optional combinations of the above components, and arrangements in which components and expressions of the present disclosure are interchanged among methods, devices, systems, and so forth, are also valid aspects of the present disclosure.

### BRIEF DESCRIPTION OF THE DRAWINGS

FIG. 1 is a side view schematically illustrating a sheet embellishing system according to an embodiment;

FIG. 2 is a top view schematically illustrating the sheet embellishing system according to the embodiment;

FIG. 3 is a block diagram illustrating functions and configurations of a control device illustrated in FIG. 1;

FIG. 4 is a diagram showing an example of a data structure in a job history information storage unit illustrated in FIG. 3;

FIG. 5 is a diagram illustrating an example of a settings screen that the control device in FIG. 1 displays on a predetermined display unit; and

FIG. 6 is a side view schematically illustrating the sheet embellishing system according to a modification.

### DESCRIPTION OF THE PREFERRED EMBODIMENTS

The present disclosure will be described below by way of a preferred embodiment, with reference to the drawings. The embodiment does not limit the disclosure but rather is exemplary, and not all features and combinations thereof described in the embodiment are necessarily essential to the disclosure. Components, members, and processing that are the same or equivalent in the drawings are denoted by the same symbols, and repetitive description will be omitted as appropriate.

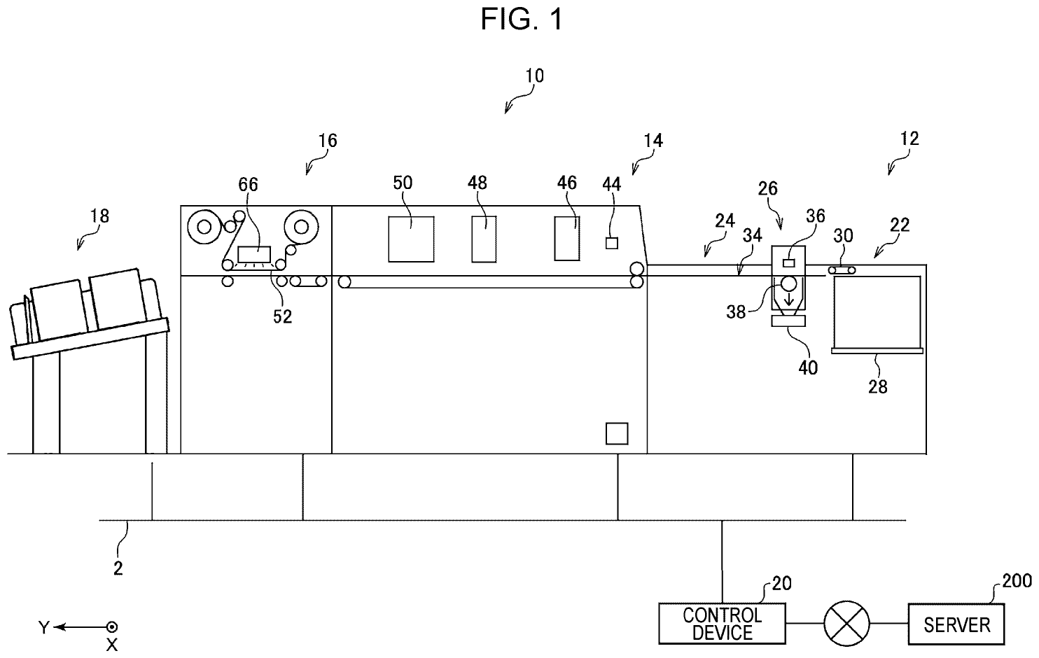

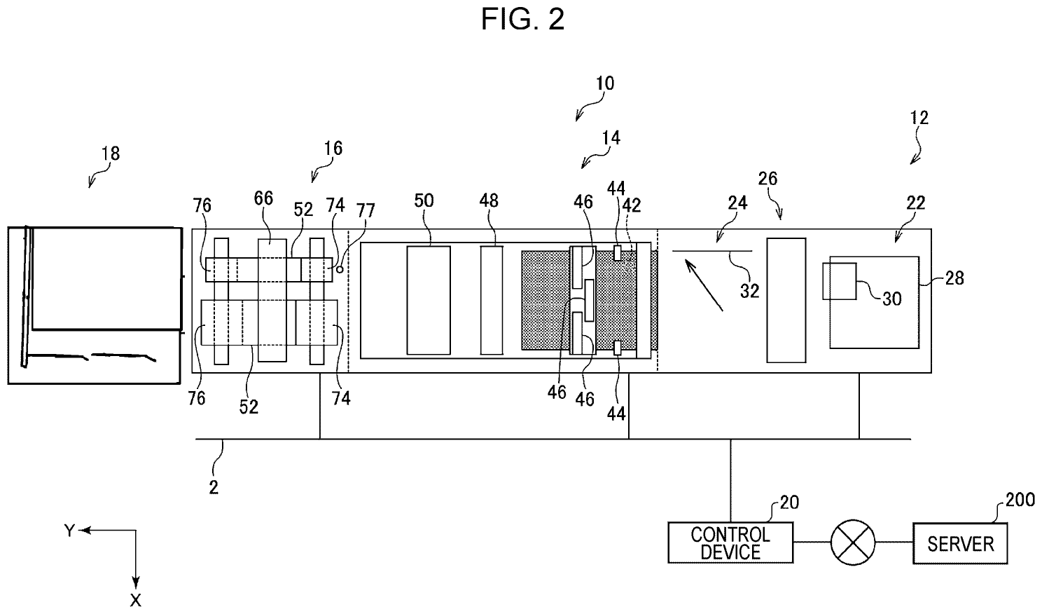

FIGS. 1 and 2 are diagrams that schematically illustrate a sheet embellishing system 10. FIG. 1 is a side view, and FIG. 2 is a top view. The sheet embellishing system 10 is a system that performs predetermined embellishment of sheets while conveying the sheets. The sheets are made of various materials, such as paper, textile, resin, metal, and so forth.

Hereinafter, a direction in which sheets are conveyed (direction from right to left in FIGS. 1 and 2) will be referred to as a conveying direction Y, and a direction orthogonal to the conveying direction Y (direction orthogonal to the drawing in FIG. 1 and also a top-bottom direction in FIG. 2) as a width direction X.

The sheet embellishing system 10 includes a sheet feeding device 12 that feeds sheets, one at a time, a varnish-applying device 14 that applies with an ultraviolet (UV) curable varnish (hereinafter, also referred to simply as “varnish”) to the sheets that are fed thereto one at a time, and irradiates the varnish by UV rays, a transfer device (foil stamping device) 16 that transfers foil, which is transfer material, onto the varnish that is applied to the sheet, taking advantage of tackiness of the varnish in a half-cured state, a stacker 18 that stacks the sheets, and a control device 20 that centrally controls the sheet embellishing system 10. The sheet feeding device 12, the varnish-applying device 14, the transfer device 16, and the stacker 18 are arrayed in a single row in this order, from an upstream side (right side in FIGS. 1 and 2) toward a downstream side in the conveying direction Y. The control device 20 is connected to the sheet feeding device 12, the varnish-applying device 14, and the transfer device 16, via a network 2.

The sheet feeding device 12 includes a feeder 22, a corona processing unit 26, and a aligning unit 24. The feeder 22 includes a table 28 and a suction head 30. Sheets are loaded on the table 28. The table 28 is configured so as to be capable of ascending and descending. The suction head 30 feeds out sheets loaded on the table 28 one at a time, in order from the top.

The corona processing unit (surface modification unit) 26 includes an electrode (application electrode) 36 that is disposed upward from a conveying path 34, and a dielectric roller (opposing electrode) 38 that is disposed downward from the conveying path 34, such that the electrode 36 and the dielectric roller 38 face each other from above and below the conveying path 34. The corona processing unit 26 performs surface modification of sheets fed out by the feeder 22, by corona discharge between the electrode 36 and the dielectric roller 38. Specifically, hydrophilicity is generated on surfaces of the sheets, thereby improving wettability. Note that conveying sheets in a state of being suctioned onto the conveying path 34 by an air suction unit 40 makes the distance between the electrode 36 and the sheets to be constant, and corona discharge is stabilized. The air suction unit 40 generates negative pressure by one of suction ports of an unillustrated venting blower being disposed, but a configuration may be made in which a suction fan is disposed to generate negative pressure.

The aligning unit 24 aligns positions of the sheets, fed out from the feeder 22, in the width direction X thereof, by performing abutting thereof against a aligning reference guide 32.

The varnish-applying device 14 includes a sheet sensor 42, at least one (three in FIG. 2) varnish-applying unit 46, a half-curing UV irradiation unit 48, and a full-curing UV irradiation unit 50. The sheet sensor 42, the varnish-applying units 46, the half-curing UV irradiation unit 48, and the full-curing UV irradiation unit 50 are provided in this order from the upstream side toward the downstream side.

The sheet sensor 42 detects sheets fed from the sheet feeding device 12.

The count of the varnish-applying units 46 is not limited in particular. The varnish-applying device 14 may include one varnish-applying unit 46 that extends over or beyond a range of the width direction X in which discharging of varnish is necessary, or may include two, or four or more, varnish-applying units 46.

The varnish-applying units 46 are line inkjet heads, although not limited thereto in particular. Under control of the control device 20, the varnish-applying units 46 discharges varnish in accordance with varnish application data, triggered by detection of a sheet by the sheet sensor 42, and thereby applies varnish to the sheet. The varnish application data is data indicating regions of the sheet to which varnish is to be applied. The regions to which varnish is to be applied may have a predetermined relation with a base image.

The UV irradiation units 48 and 50 emit UV rays under control of the control device 20. The UV irradiation units 48 and 50 typically use light-emitting diodes (LEDs) as light sources thereof, but other light sources, such as light bulbs, fluorescent lamps, or the like may be used, as long as they are light sources that emit UV rays. The light sources of the UV irradiation units 48 and 50 are capable of adjustment of UV emission intensity of UV rays emitted.

The half-curing UV irradiation unit 48 irradiates the varnish on the sheets with UV rays of which output is relatively weak, so as to perform half-curing of the varnish. Half-curing is curing to a degree in which fluidity of the varnish is reduced, but the varnish is not completely cured, and can be further cured from this state, for example. The varnish in the half-cured state is full-cured by the transfer device 16. Full-curing is to completely cure the varnish. In cases in which no foil is to be transferred to the sheets, the half-curing UV irradiation unit 48 is normally turned off. Note that the half-curing UV irradiation unit 48 may be used in cases in which no foil is to be transferred to the sheets. For example, in a case in which the varnish applied onto the sheets tends to bleed, the half-curing UV irradiation unit 48 is turned on to perform half-curing of at least the surface of the varnish. Thus, bleeding of the varnish can be suppressed.

The full-curing UV irradiation unit 50 irradiates the varnish applied onto the sheets with UV rays, so as to perform full-curing of the varnish. In cases in which foil is to be transferred to the sheets, the full-curing UV irradiation unit 50 is turned off.

That is to say, in cases of transferring foil to the sheets, half-curing of the varnish is performed by the half-curing UV irradiation unit 48, and full-curing of the varnish in the half-cured state is performed by a transferring UV irradiation unit 66 of the transfer device 16. In such cases, the full-curing UV irradiation unit 50 is turned off.

In cases of not transferring foil to the sheets, i.e., in cases of only applying varnish to the sheets, the varnish is full-cured by the full-curing UV irradiation unit 50. In such cases, the half-curing UV irradiation unit 48 and the transferring UV irradiation unit 66 of the transfer device 16 are turned off. Note that as described above, the half-curing UV irradiation unit 48 may be turned on even in cases of not transferring foil.

The transfer device 16 conveys the sheets, and also conveys a web (transfer web) 52 by roll-to-roll, brings these into contact with each other. That is to say, the web that is being conveyed by roll-to-roll is brought into contact with the sheets that are being conveyed. Thus, the foil borne by the web 52 adheres to the varnish in the half-cured state on the sheets. In this state, i.e., in a state in which the foil is borne by the web 52 but is also adhering to the varnish in the half-cured state, the transferring UV irradiation unit 66 irradiates the varnish in the half-cured state by UV rays, thereby performing full-curing of the varnish. Once the varnish is full-cured, the force of the foil adhering to the varnish is greater than the force of the web 52 bearing the foil. Conveying the sheet and separating the web 52 from the sheet in this state transfers the foil that was borne by the web 52 to the varnish on the sheet.

The transferring UV irradiation unit 66 emits UV rays under control of the control device 20. The transferring UV irradiation unit 66 typically uses LEDs as the light source thereof, but other light sources, such as light bulbs, fluorescent lamps, or the like may be used, as long as they are light sources that emit UV rays, in the same way as with the UV irradiation units 48 and 50. The light source of the transferring UV irradiation unit 66 is capable of adjustment of UV emission intensity of UV rays emitted.

The stacker 18 stacks sheets (embellished sheets) that are carried out from the transfer device 16.

The control device 20 controls operations of the sheet embellishing system 10 in general. The control device 20 accepts input regarding definitions of jobs. The control device 20 may display a predetermined job management screen, and accept input of definitions of jobs. Definitions of jobs can include a count of sheets to be subjected to embellishment (count of prints to be processed), size of sheets to be subjected to embellishment, and varnish discharge data, for example. The control device 20 controls the sheet feeding device 12, the varnish-applying device 14, and the transfer device 16, on the basis of the definitions of jobs.

The control device 20 is connected to a server 200 that is situated externally, via a network such as the Internet or the like. The server 200 is a server that a manufacturer 202 manages. The manufacturer 202 is a corporation that manufactures the sheet embellishing system. The term “manufacturer 202 manages” here includes not only cases in which the manufacturer 202 directly performs management, but also cases in which a corporation commissioned by the manufacturer 202 performs management.

This so far is the overall configuration of the sheet embellishing system 10.

As a modification, the sheet embellishing system 10 may be equipped with a printing device that prints images on the sheets, instead of the sheet feeding device 12, in which sheets are fed from this printing device one sheet at a time.

Also, the sheet embellishing system 10 may be equipped with other devices between the transfer device 16 and the stacker 18, such as post-processing devices or the like.

Now, (a) curability of the varnish, i.e., the total light intensity of UV rays that is necessary for half-curing or full-curing of the varnish, differs for each type of varnish. For example, in a case of performing half-curing of varnish, the varnish will not be half-cured if the total light intensity of UV rays by which the varnish is irradiated is too small, but the varnish will be full-cured if the total light intensity of UV rays by which the varnish is irradiated is too great.

Also, (b) the desired degree of half-curing, i.e., hardness, differs depending on the type of foil, and there are foils regarding which harder half-curing is better, and there are foils regarding which softer half-curing is better. Specifically, the ease of the foil to peel away from the web 52 differs depending on the type of foil, and accordingly the degree of half-curing, i.e., the degree of tackiness necessary for the varnish, differs depending on the type of foil. Accordingly, even when the same varnish is being used, the total light intensity of UV rays that is necessary for half-curing of the varnish differs if the type of foil differs. Also, (c) in a case of soft half-curing, the total light intensity of UV rays in the full-curing will need to be greater than in a case of hard half-curing. That is to say, even when the same varnish is being used, the total light intensity of UV rays that is necessary for full-curing of the varnish differs if the type of foil differs.

Also, (d) transmittance of UV rays that are transmitted through the foil differs in accordance with the type of foil. Hence, even when the UV emission intensity of UV rays being emitted by the transferring UV irradiation unit 66 is the same, the total light intensity of UV rays with which the varnish is irradiated differs if the type of foil differs. When the total light intensity is too small, the varnish will not be full-cured, and when the total light intensity is too great, the foil may be damaged.

The total light intensity of UV rays by which the varnish is irradiated can be controlled by adjusting the UV emission intensity of the UV irradiation units, which is one of control items of the sheet embellishing system 10. The stronger the UV emission intensity is, the greater the total light intensity of UV rays by which the varnish is irradiated becomes, and the weaker the UV emission intensity is, the smaller the total light intensity of UV rays by which the varnish is irradiated becomes. However, the above (a), (b), (c), and (d) need to be taken into consideration, and accordingly adjusting the UV emission intensity is difficult and is a burden on the user.

Accordingly, in the present embodiment, the control device 20 stores job history of jobs performed in the past (hereinafter, referred to as “past jobs”), and proposes candidates for UV emission intensity for a job to be currently executed this time (hereinafter, referred to as “current job”) based on the job history of past jobs, thereby reducing the burden on the user.

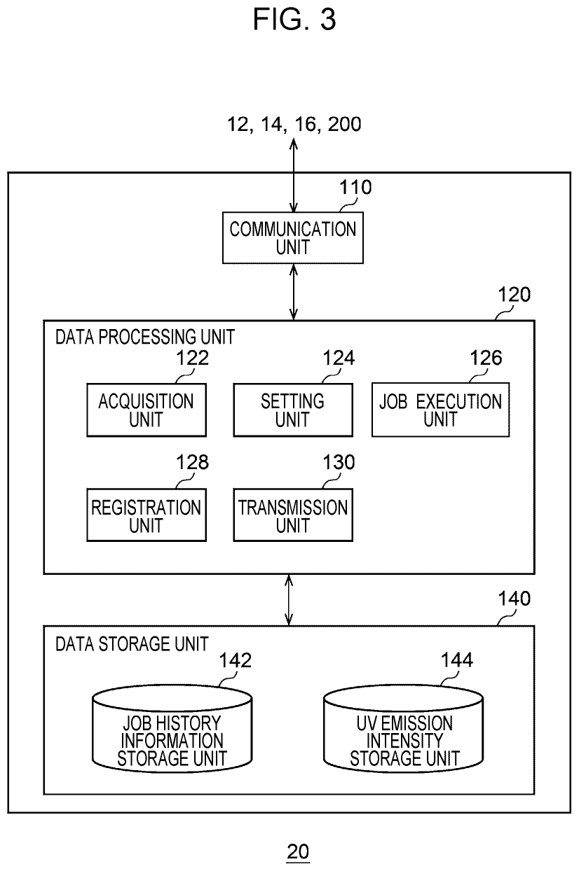

FIG. 3 is a block diagram illustrating functions and configurations of the control device 20. The functional blocks illustrated here can be realized hardwarewise by devices such as processors like a central processing unit (CPU) or the like and memory like read-only memory (ROM) and random access memory (RAM) and so forth of a computer, and mechanical devices, and can be realized softwarewise by computer programs and so forth. Accordingly, one skilled in the art will appreciate that these functional blocks can be realized in various forms, such as hardware alone, software alone, or combinations thereof.

The control device 20 includes a communication unit 110, a data processing unit 120, and a data storage unit 140. The communication unit 110 communicates with other devices in accordance with predetermined communication protocols. The data processing unit 120 executes various types of data processing. The data storage unit 140 stores data that is referenced by or updated by the data processing unit 120.

The data storage unit 140 includes a job history information storage unit 142 and an UV emission intensity storage unit 144.

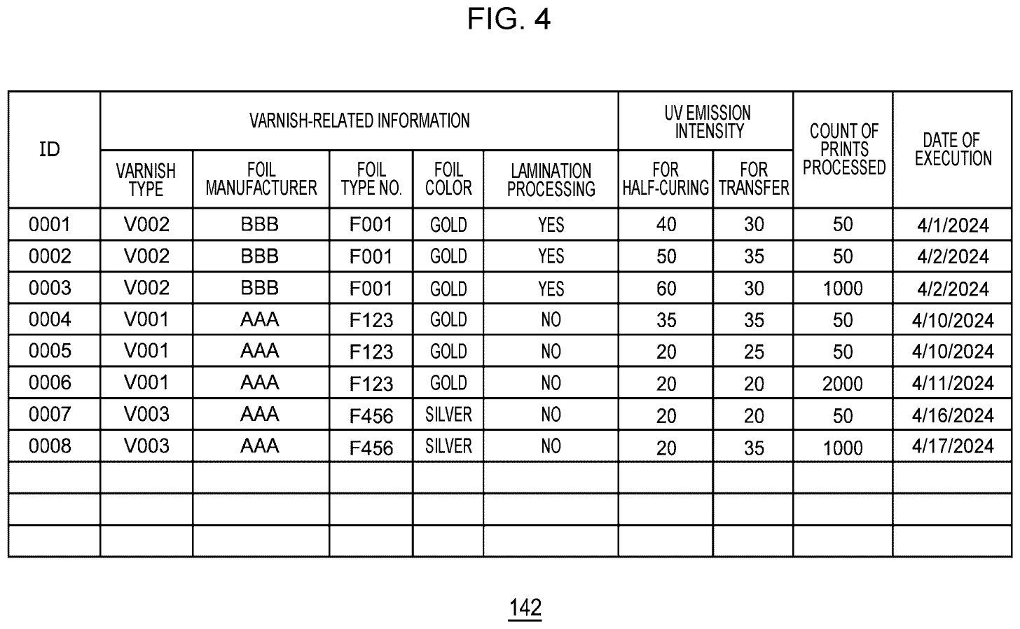

FIG. 4 is a diagram showing an example of a data structure in the job history information storage unit 142. The job history information storage unit 142 stores history of past jobs. Specifically, the job history information storage unit 142 stores, with respect to past jobs, adhesivity-related information that is information relating to adhesivity between varnish on the sheets and transfer material to be transferred to the varnish on the sheets, the UV emission intensity of UV rays emitted by each of the half-curing UV irradiation unit 48 and the transferring UV irradiation unit 66, the count of prints processed, and date of execution, i.e., the date of registration, in a correlated manner. Note that the job history information storage unit 142 may further store the UV emission intensity of UV rays emitted by the full-curing UV irradiation unit 50.

The adhesivity-related information includes the type of varnish applied to the sheets, the type of foil in a case of transferring foil to the varnish, and whether or not lamination processing is performed. Examples of the type of varnish include varnish type number, as shown in the example in FIG. 4. Examples of the type of foil include foil manufacturer, foil type number, and foil color, as shown in the example in FIG. 4.

Lamination processing is processing that is performed in advance, prior to application of varnish, and is processing for applying a resin thin film to the surface of the sheets. The varnish that is applied does not permeate lamination-processed sheets. That is to say, a photoinitiator contained in the varnish does not permeate the lamination-processed sheets. Accordingly, in a case in which the sheets are lamination-processed, i.e., lamination processing is “YES”, the amount of the photoinitiator remaining in the varnish on the sheets is greater as compared to a case in which the sheets are not lamination-processed, i.e., lamination processing is “NO”, and the total light intensity of UV rays necessary for half-curing or full-curing of the varnish will be smaller.

Information items regarding adhesivity-related information according to the present embodiment are all information relating to the varnish on the sheets. Accordingly, in the present embodiment, the adhesivity-related information can be also understood as being varnish-related information.

Returning to FIG. 3, the UV emission intensity storage unit 144 stores values of the UV emission intensity of UV rays emitted by the UV irradiation units in the current job.

The data processing unit 120 is equipped with an acquisition unit 122, a setting unit 124, a job execution unit 126, a registration unit 128, and a transmission unit 130.

The acquisition unit 122 references the job history information storage unit 142 and acquires values for UV emission intensity in the past jobs from history information of past jobs that have adhesivity-related information corresponding to the adhesivity-related information of the current job.

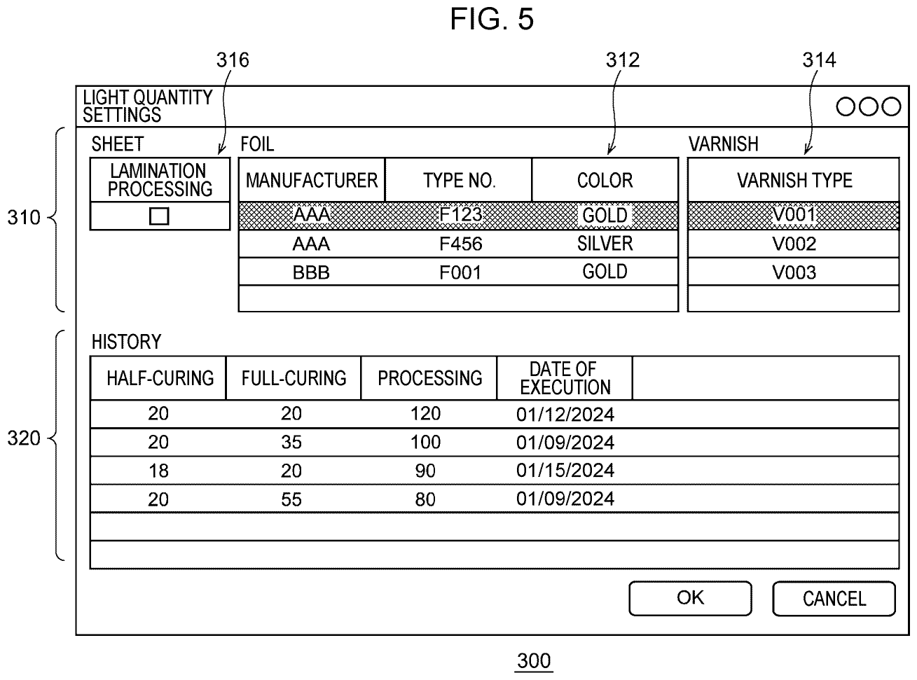

Specifically, the acquisition unit 122 first acquires the adhesivity-related information for the current job. In order to do so, the acquisition unit 122 displays a setting screen, which will be described later with reference to FIG. 5, on a predetermined display unit, for example. The user inputs the adhesivity-related information to the setting screen. The acquisition unit 122 acquires the adhesivity-related information that is input to the setting screen. Note that the acquisition unit 122 may acquire the type of varnish from a radio-frequency identification (RFID) tag that is attached to a varnish container, by a reader that is not illustrated.

Next, the acquisition unit 122 references the job history information storage unit 142 and acquires values for UV emission intensity in past jobs that have adhesivity-related information corresponding to the adhesivity-related information of the current job.

Corresponding adhesivity-related information means matching adhesivity-related information, and in the present embodiment means that the type of varnish, the type of foil, and whether or not lamination processing is performed, in the current job, matches the type of varnish, the type of foil, and whether or not lamination processing is performed, in a past job.

For example, in a case in which the information stored in the job history information storage unit 142 is that shown in FIG. 4, and the type of varnish is “V001”, the manufacturer, type number, and color of the foil are “AAA, F123, gold”, and whether or not lamination processing is performed is “NO”, in the adhesivity-related information of the current job, values of the UV emission intensity of job history with IDs of “0004”, “0005”, and “0006” are acquired.

As a modification, corresponding adhesivity-related information may be matching or similar adhesivity-related information. Similar adhesivity-related information may mean that, in a case in which the adhesivity-related information includes a plurality of information items, the value of a predetermined information item of the plurality of information items matches and the value of at least one of the other information items does not match, or may mean that values of an optional part of the information items out of the plurality of information items match and values of the other information items do not match. Alternatively, similar adhesivity-related information may mean that a value of a certain information item out of the adhesivity-related information is proximal, such as the difference thereof being no greater than 5%, for example.

In a case of the acquisition unit 122 acquiring the values of one or a plurality of UV emission intensities, the setting unit 124 displays the values of one or a plurality of UV emission intensities on the predetermined display unit, as candidates for the values of the UV emission intensity for the current job. Also, the setting unit 124 sets the values of the UV emission intensity that is selected from the candidates by the user as the values for UV emission intensity in the current job, i.e., performs registration thereof in the UV emission intensity storage unit 144. Accordingly, the setting unit 124 displays a selection screen including values of one or a plurality of UV emission intensities acquired by the acquisition unit 122, on the predetermined display unit, as candidates of values for UV emission intensity in the current job. The user selects values of UV emission intensity from the one or plurality of candidates in the selection screen. The setting unit 124 accepts the selection of the values of UV emission intensity from the user, and sets the selected values of the UV emission intensity as the values of UV emission intensity in the current job.

Values of UV emission intensity may be changed from the values selected from the candidates. For example, the values of UV emission intensity may be fine-tuned from the values selected from the candidates. Note that the UV emission intensity may be manually input, instead of being selected from among candidates. However, using values of UV emission intensity acquired from history information of past jobs enables the values of the UV emission intensity of the current job to be easily decided.

Upon accepting an execution start instruction for the job from the user, the job execution unit 126 controls each of the devices and executes the job for embellishment of the sheets. At this time, the UV irradiation units 48 and 66 emit UV rays of the UV emission intensity stored in the UV emission intensity storage unit 144.

In a case in which the job is executed, the registration unit 128 registers information relating to the job, more specifically values of each of the information items in FIG. 4, in the job history information storage unit 142 at a predetermined timing. That is to say, the registration unit 128 registers adhesivity-related information of the job, values of UV emission intensity, the count of prints processed, and the date of execution, in the job history information storage unit 142. The predetermined timing may be when the job execution unit 126 accepts the execution start instruction for the job from the user, or may be when execution of the job ends, for example.

The transmission unit 130 transmits history information of the job stored in the job history information storage unit 142 to the server 200 that is situated externally. The transmission unit 130 may transmit history information of jobs at a predetermined cycle, or may perform transmission when execution of jobs ends, although not limited thereto in particular. Either way, history information of jobs is collected from a plurality of sheet embellishing systems 10 to the server 200. Accordingly, a manufacturer that provides the sheet embellishing systems 10 can comprehend UV emission intensities that are appropriate in accordance with various types of adhesivity-related information by analyzing the history information thereof, and make proposals with respect thereto. Note that service staff may make on-site visits or the like to collect the information stored in the job history information storage unit 142 to the server 200 using recording media, mobile terminal devices, or the like.

FIG. 5 is a diagram illustrating an example of a setting screen 300. The setting screen 300 includes an adhesivity-related information region 310 and a history information region 320. The adhesivity-related information region 310 includes a foil information region 312, a varnish information region 314, and a sheet information region 316. Information of the foil to be used in the current job is input to the foil information region 312. In this example, a list of foils registered in advance is displayed in the foil information region 312, and accordingly all that is necessary is to select the foil to be used for the current job therefrom. Information of the varnish to be used in the current job is input to the varnish information region 314. In this example, a list of varnishes registered in advance is displayed in the varnish information region 314, and accordingly all that is necessary is to select the varnish to be used for the current job therefrom. Whether or not lamination processing is performed on the sheets to be used for the current job is input to the sheet information region 316. In this example, when there is lamination processing, the checkbox is checked, and when there is no lamination processing, the checkbox is unchecked. The acquisition unit 122 accepts information that is input to each of the information items of the adhesivity-related information region 310 as adhesivity-related information for the current job.

History information of past jobs having adhesivity-related information corresponding to the adhesivity-related information of the current job that is input to the adhesivity-related information region 310 is displayed in the history information region 320. More specifically, the acquisition unit 122 acquires, from the job history information storage unit 142, history information of past jobs having adhesivity-related information corresponding to the adhesivity-related information of the current job that is input to the adhesivity-related information region 310, and performs display thereof in the history information region 320.

In this example, the acquisition unit 122 acquires the count of prints processed and the date of execution as well, in addition to the UV emission intensity, and performs display of these in the history information region 320 as well. Jobs with a great count of prints processed, and jobs of which the date of execution is recent, have a high likelihood of the UV emission intensity being appropriate. Accordingly, displaying the count of prints processed, and the date of execution as well, facilitates selection of UV emission intensity that is appropriate.

Next, advantages that the present embodiment yields will be described. According to the embodiment, the UV emission intensities in past jobs with corresponding adhesivity-related information are presented as candidates for UV emission intensity of the current job. The user may use the candidates for UV emission intensity as they are presented without change, or may fine-tune the candidates for UV emission intensity that are presented. Either way, presenting candidates for UV emission intensity reduces the burden on the user for the adjustment.

The present disclosure has been described so far by way of the embodiment. One skilled in the part will appreciate that this embodiment is exemplary, that various modifications can be made regarding combinations of the components and the processing processes thereof, and that such modifications also fall within the scope of the present disclosure. Such modifications will be described below.

### Modification 1

The total light intensity of the UV rays by which the varnish is irradiated is not limited to being controlled by adjusting the UV emission intensity, and can also be controlled by adjusting the values of other control items of the sheet embellishing system 10 that affect the total light intensity of the UV rays by which the varnish on the sheets is irradiated. Accordingly, the technical idea of the embodiment can also be applied to cases of proposing candidates of values of other control items, either in addition to UV emission intensity or instead of UV emission intensity. In this case, the job history information storage unit 142 stores values of the other control items from past jobs as job history of past jobs, the acquisition unit 122 acquires the values of the other control items in past jobs with corresponding adhesivity-related information, and the setting unit 124 performs presentation thereof as candidates of the values of the other control items in the current job.

An other control item may be a conveying speed of the sheets passing through the irradiation range of the UV irradiation unit. The slower the conveying speed of the sheet is, the longer the amount of time during which the varnish is irradiated by UV rays from the UV irradiation unit will be, and the total light intensity of UV rays by which the varnish is irradiated is greater. The faster the conveying speed of the sheet is, the shorter the amount of time during which the varnish is irradiated by UV rays from the UV irradiation unit will be, and the total light intensity of UV rays by which the varnish is irradiated is smaller.

### Modification 2

The server 200 that is situated externally may be equipped with a job history information storage unit, unlike the embodiment and the above Modification. History information of past jobs, collected from a plurality of sheet embellishing systems 10, may be stored in this job history information storage unit. In this case, the acquisition unit 122 may acquire candidates of values for control items from the job history information storage unit of the server 200 via the network.

### Modification 3

While the adhesivity-related information includes the type of varnish, the type of foil, and whether or not lamination processing is performed, in the embodiment and the above Modifications, this is not limiting.

The adhesivity-related information may include just the type of varnish, or include just the type of foil, or include just whether or not lamination processing is performed.

Also, the adhesivity-related information may include at least one other information item, in addition to at least one of the type of varnish, the type of foil, and whether or not lamination processing is performed, or instead of the type of varnish, the type of foil, and whether or not lamination processing is performed.

The other information item may be the thickness of the varnish applied onto the sheets, for example. Note that the thicker the varnish is, the more the total light intensity needs to be increased.

The other information item may be the color of the region on the sheets where the varnish is to be applied (hereinafter, also referred to as “base color”), for example. In addition to the direct light of the UV rays emitted from the UV irradiation unit, reflected light of UV rays reflected at the sheet also contributes to curing of the varnish, and the higher the UV-ray reflectance of the sheet is, the more the curing of the varnish is promoted. The UV-ray reflectance of the sheets differs depending on the base color thereof.

The base color in a case in which varnish is to be applied to a printed region of a sheet is the color of the ink printed on the sheet. Now, generally, printing devices perform printing using four colors of ink, which are cyan, magenta, yellow, and black. These four colors of ink differ depending on at least the manufacturer of the printing device, and can even differ among printing devices from the same manufacturer. Specifically, even if inks are given the same color name, UV-ray reflectance can differ, due to difference in pigments or the like, for example. In some cases, the appearance of the colors can differ slightly. Accordingly, the other information item may be a combination of the base color and identification information of the printing device that was used to print the base color, for example. The identification information of the printing device may include at least one of information for distinguishing the manufacturer of the printing device, information for distinguishing the model number, and information for distinguishing the product number.

The base color in a case in which varnish is to be applied to an unprinted region of a sheet is the color of the sheet itself. Now, even if sheets are given the same color name, sheets with different product numbers or different manufacturers, for example, can differ in UV-ray reflectance, due to difference in pigments and so forth, for example. In some cases, the appearance of the colors can also differ slightly. Also, even if sheets are given the same color name, sheets with different product numbers or different manufacturers, for example, differ in degree of permeation of varnish to the sheets due to differences in minute asperities on the surface of the sheets, difference in thickness of coating agents applied to the surface of the sheets, and so forth, leading to difference in the degree of permeation of the photoinitiator contained in the varnish into the sheet, and consequently difference in the total light intensity of UV rays necessary for half-curing or full-curing of the varnish. Accordingly, the other information item may be identification information for identifying the sheets, for example. The identification information of the sheets may include at least one of information for distinguishing the manufacturer of the sheets, information for distinguishing the model number of the sheets, and information for distinguishing the product number of the sheets.

The other information item may be the type of finish of lamination processing. Difference in the type of finish can affect the UV-ray reflectance of the sheets. The types of finish may be matte and glossy.

These other information items are all varnish-related information. Accordingly, the adhesivity-related information can be also understood as being varnish-related information.

### Modification 4

The control device 20 may be equipped with a control item value storage unit that stores values of control items for each adhesivity-related information, unlike the embodiment and the above Modifications. The values of the control items may be values that the user of the sheet embellishing system 10 has decided on the basis of experimentation, for example. Also, the values of the control items may be values that manufacturer of the sheet embellishing system 10 has decided on the basis of job history of past jobs collected, experimentation, or the like, for example. The acquisition unit 122 may acquire values of control items corresponding to the adhesivity-related information of the current job, from the control item value storage unit.

### Modification 5

While values of control items acquired by the acquisition unit 122 were presented to the user as candidates of values for control items of the current job in the embodiment and the above Modifications, this is not limiting, and the setting unit 124 may set the values of the control items acquired by the acquisition unit 122 as the values of the control items of the current job. In this case, the values of the control items are set automatically on the basis of the adhesivity-related information of the current job. In a case in which the acquisition unit 122 acquires values of control items for a plurality of past jobs, the values of the control items of the past job with the greatest count of prints processed may be employed, or the values of the control items of the past job of which the date and time of registration is the most recent may be employed.

### Modification 6

The technical idea of the embodiment is not limited to cases of transferring onto sheets. That is to say, transfer-receiving material onto which the transfer device 16 transfers the transfer material may be other than sheets.

### Modification 7

In the embodiment, foil was transferred onto varnish on the sheets, using the tackiness of the varnish in a half-cured state. In the present Modification, the foil has an adhesion function that is exhibited by being heated, and the foil is transferred to the varnish using this adhesion function. Description will be made below, primarily with respect to points of difference from the embodiment.

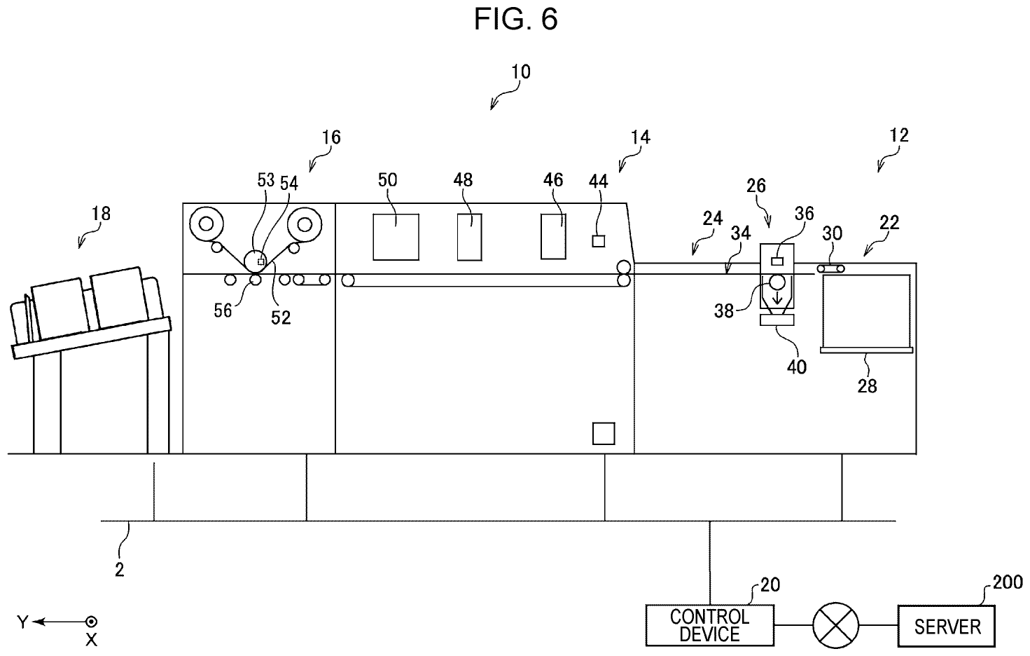

FIG. 6 is a side view schematically illustrating the sheet embellishing system 10 according to the Modification. FIG. 6 corresponds to FIG. 1.

The varnish-applying device 14 turns on the half-curing UV irradiation unit 48 and performs half-curing of at least the surface of the varnish, in a case in which the varnish applied onto the sheets readily bleeds. Note that the varnish-applying device 14 does not have to be equipped with the half-curing UV irradiation unit 48.

The foil borne by the web 52 has an adhesive layer that exhibits adhesion force by being heated. That is to say, the foil borne by the web 52 exhibits the adhesion force by being heated.

The transfer device 16 is not equipped with a transferring UV irradiation unit. Instead, the transfer device 16 is equipped with a pressure roller 53, an opposing member 56 that is disposed downward from the pressure roller 53 and opposes the pressure roller 53, and a heating unit (e.g., a heater) 54 for heating the foil. The pressure roller 53 presses the web 52 and the sheet against the opposing member 56. The opposing member 56 is a roller in the example that is illustrated. Note that it is sufficient for the opposing member 56 to be capable of nipping the web 52 and the sheet between itself and the pressure roller 53, and is not limited to being a roller. For example, the opposing member 56 may be a guide plate making up part of a conveying face.

At least one of the pressure roller 53 and the opposing member 56 is configured so as to be capable of ascending/descending. By at least one of the pressure roller 53 and the opposing member 56 ascending/descending, a gap between the pressure roller 53 and the opposing member 56, in other words, the pressure of the pressure roller 53 pressing the web 52 and the sheet against the opposing member 56, can be adjusted.

The pressure roller 53 is heated by the heating unit (e.g., heater) 54. That is to say, the pressure roller 53 heats the foil borne by the web 52, and also presses the foil against the sheet. Accordingly, the adhesion force of the foil is exhibited, and the foil is adhered to, i.e., transferred to, the surface of the varnish that is situated higher than an upper face of the sheet.

The heating unit 54 may be built into the pressure roller 53 as illustrated, or may be disposed outside of the pressure roller 53. In a case in which the heating unit 54 is to be disposed outside of the pressure roller 53, placement thereof is preferably such that the web 52, and consequently the foil, are heated on the upstream side of the pressure roller 53, in order for the foil to be able to exhibit sufficient adhesion force when being transferred.

Note that the method of heating the foil is not limited to this. For example, a roller other than the pressure roller 53 may be heated by the heating unit 54, and this roller may heat the foil. Also, a hot air fan, for example, may serve as the heating unit 54 and heat the foil.

Now, the adhesive agent that is contained in the adhesive layer of the foil can differ depending on the type of foil. Accordingly, the amount of energy necessary of the adhesive layer to exhibit sufficient adhesive force can differ for each type of foil. When the adhesive layer cannot exhibit sufficient adhesive force, adhesion defects, in which the foil is not transferred to the sheet, can occur.

The amount of energy to be applied to the adhesive layer of the foil can be controlled by adjusting the heating temperature by the heating unit 54, which is a control item of the sheet embellishing system 10. This adjustment is cumbersome, and can be a burden on the user.

Accordingly, in the present Modification, the control device 20 stores job history of past jobs, and proposes candidates for heating temperature by the heating unit 54 in the current job, which is to be executed next, on the basis of job history of the past jobs, thereby reducing the burden on the user.

The job history information storage unit 142 of the control device 20 stores the adhesivity-related information, the heating temperature by the heating unit 54, the count of prints processed, and the date of execution, i.e., the date of registration, of jobs in the past, in a correlated manner.

The adhesivity-related information includes the type of foil. Examples of the type of foil include the manufacturer of the foil, the type number of the foil, and the color of the foil.

The acquisition unit 122 references the job history information storage unit 142, and acquires, from history information of a past job that has adhesivity-related information corresponding to the adhesivity-related information of the current job, a value for the heating temperature by the heating unit 54 of this past job.

In a case of the acquisition unit 122 acquiring one or a plurality of values of heating temperature, the setting unit 124 displays the one or plurality of values of heating temperature on the predetermined display unit, as candidates for the value of heating temperature for the current job. The setting unit 124 also sets the value of the heating temperature selected by the user from among the candidates as the value of the heating temperature by the heating unit 54 in the current job, i.e., registers the value of the heating temperature in the data storage unit 140.

Note that the amount of energy applied to the adhesive layer of the foil can also be controlled by adjusting values of other control items of the transfer device 16, and is not limited to control by adjusting the heating temperature by the heating unit 54. Accordingly, the job history information storage unit 142 may store values of other control items in past jobs, either in addition to the heating temperature by the heating unit 54 or instead of the heating temperature by the heating unit 54, with the acquisition unit 122 acquiring the values of the other control items from past jobs with corresponding adhesivity-related information, and the setting unit 124 performing presentation thereof as candidates of values of the other control items in the current job.

An other control item may be conveying speed (feeding speed) of the web 52. The slower the conveying speed of the web 52 is, the longer the amount of time during which the foil is heated will be, and the amount of energy applied to the foil will be greater. The faster the conveying speed of the web 52 is, the shorter the amount of time during which the foil is heated will be, and the amount of energy applied to the foil will be smaller.

Now, adhesion defects, in which the foil is not transferred, can occur in cases in which the gap between the pressure roller 53 and the opposing member 56, in other words, the pressure of the pressure roller 53 pressing the web 52 and the sheet against the opposing member 56, is not appropriate, as well. Adjustment of this gap is cumbersome, and can be a burden on the user. Accordingly, the other control item may be the gap between the pressure roller 53 and the opposing member 56, or the pressure of the pressure roller 53 pressing the web 52 and the sheet against the opposing member 56.

According to the present Modification, presenting candidates for values of control items reduces the burden on the user for adjustment thereof.

### Modification 8

The web 52 that bears the foil is normally made by creating a transfer layer by vapor deposition, application or adhering metal, colorant, or the like, onto a base film, and the transfer layer is the “foil” that is the transfer material. Also, a separation layer, an adhesive layer, or the like, may be added such that the transfer layer has excellent adhesivity, and has excellent separability from the base film, at the time of transfer. Also, the elongated base sheet that bears the transfer material is not limited to film, and it is sufficient for the elongated base sheet to be any material as long as it is capable of holding the transfer material and transferring onto the transfer-receiving material in a transfer zone, such as band-like woven fabric or the like. On the other hand, the transfer material that is borne by the web 52 is not limited to “foil”, and may be a thin layer other than metal. Also, an article in which a transfer material such as ink or the like is applied to the web serving as a substrate, such as an ink ribbon, may be used. Also, the elongated base sheet that bears the transfer material is not limited to film, and it is sufficient for the elongated base sheet to be any material as long as it is capable of holding the transfer material and transferring onto the transfer-receiving material in a transfer zone, such as band-like woven fabric or the like.

Optional combinations of the above-described embodiment and Modifications are also valid embodiments of the present disclosure. New embodiments generated through combination have the advantages of both of the embodiment and the Modifications that are combined.

Generalizing the above-described embodiment and Modifications yields the following Aspects.

### Aspect 1

A sheet embellishing system that performs embellishment on a sheet while conveying the sheet, the sheet embellishing system including:
a varnish-applying unit that applies varnish having ultraviolet (UV) curability onto the sheet;
a UV irradiation unit that irradiates the varnish on the sheet by UV rays; and
a control device, wherein
the control device acquires, from a storage unit that stores adhesivity-related information that is information relating to adhesivity between the varnish on the sheet and a transfer material that is to be transferred into the varnish on the sheet, and a value regarding a control item of the sheet embellishing system, in a correlated manner, a value of the control item of which the adhesivity-related information corresponds to the adhesivity-related information of a current job, and executes predetermined processing using the value of the control item that is acquired.

### Aspect 2

The sheet embellishing system according to Aspect 1, wherein
the adhesivity-related information is information relating to the varnish on the sheet.

### Aspect 3

The sheet embellishing system according to Aspect 1 or 2, wherein
the adhesivity-related information includes at least one of type of the varnish on the sheet, thickness of the varnish on the sheet, color of a region on the sheet in which the varnish is to be applied, and type of foil in a case in which foil is to be transferred onto the varnish on the sheet.

### Aspect 4

The sheet embellishing system according to any one of Aspects 1 to 3, wherein
the predetermined processing is to display the value that is acquired on a predetermined display unit as a candidate for the value of the control item.

### Aspect 5

The sheet embellishing system according to any one of Aspects 1 to 3, wherein
the predetermined processing is to set the value that is acquired to the value of the control item for the current job.

### Aspect 6

The sheet embellishing system according to any one of Aspects 1 to 5, wherein
the control item is a control item of the sheet embellishing system that affects a total light intensity of UV rays by which the varnish on the sheet is irradiated.

### Aspect 7

The sheet embellishing system according to any one of Aspects 1 to 6, wherein
the control item is UV emission intensity of UV rays emitted by the UV irradiation unit.

### Aspect 8

The sheet embellishing system according to Aspect 7, wherein
the value that is acquired is a value of UV emission intensity for the UV irradiation unit to perform half-curing of the varnish on the sheet.

### Aspect 9

The sheet embellishing system according to Aspect 7, wherein
the value that is acquired is a value of UV emission intensity for the UV irradiation unit to perform full-curing of the varnish on the sheet.

### Aspect 10

The sheet embellishing system according to any one of Aspects 1 to 9, wherein
the control item is conveying speed of the sheet passing through an irradiation range of the UV irradiation unit.

### Aspect 11

The sheet embellishing system according to any one of Aspects 1 to 10, further including:
a transfer device that conveys a transfer web bearing the transfer material by roll-to-roll, brings the transfer web into contact with the varnish on the sheet, and transfers the transfer material from the transfer web, wherein
the transfer material exhibits adhesion force by being heated,
the transfer device includes a heating unit for heating the transfer material, and
the control item is a heating temperature by the heating unit.

### Aspect 12

The sheet embellishing system according to any one of Aspects 1 to 10, further including:
a transfer device that conveys a transfer web bearing the transfer material by roll-to-roll, brings the transfer web into contact with the varnish on the sheet, and transfers the transfer material from the transfer web, wherein
the transfer material exhibits adhesion force by being heated,
the transfer device includes a heating unit for heating the transfer material, and
the control item is a conveying speed of the transfer web.

### Aspect 13

The sheet embellishing system according to any one of Aspects 1 to 12, wherein
in a case in which a job is executed, the control device stores the value set to the control item in the storage unit.

### Aspect 14

The sheet embellishing system according to any one of Aspects 1 to 13, wherein
the control device accepts adhesivity-related information for the current job from a user.

### Aspect 15

The sheet embellishing system according to any one of Aspects 1 to 14, wherein
a server that is externally situated is equipped with the storage unit, and
the control device acquires a value of the control item, of which the adhesivity-related information corresponds to the adhesivity-related information of the current job, from the storage unit of the server via a network.

### Aspect 16

A sheet embellishing method, including:
a first step of acquiring adhesivity-related information that is information relating to adhesivity between varnish applied onto a sheet and a transfer material that is to be transferred onto the varnish on the sheet, regarding a current job;
a second step of referencing a storage unit that stores the adhesivity-related information in past jobs, and a value regarding a control item of a sheet embellishing system, in advance in a correlated manner, identifying at least one history information of a past job that has the adhesivity-related information corresponding to the adhesivity-related information of the current job, and acquiring a value regarding the control item in the past job that is identified;
a third step of executing predetermined processing using the value of the control item that is acquired, and setting the value of the control item in the current job; and
a fourth step of executing the current job by the value of the control item in the current job that is set, wherein
the sheet is embellished by irradiating and curing, by UV rays, UV curable varnish that is applied onto the sheet, while conveying the sheet, and also transferring the transfer material onto the varnish, by executing the current job.

### Aspect 17

The sheet embellishing method according to Aspect 16, wherein
the adhesivity-related information is information relating to the varnish on the sheet.

### Aspect 18

The sheet embellishing method according to Aspect 16 or 17, wherein
the adhesivity-related information includes at least one of type of the varnish on the sheet, thickness of the varnish on the sheet, color of a region on the sheet in which the varnish is to be applied, and type of foil in a case in which foil is to be transferred onto the varnish on the sheet.

### Aspect 19

The sheet embellishing method according to any one of Aspects 16 to 18, wherein
the predetermined processing is to display the value that is acquired on a predetermined display unit as a candidate for the value of the control item, and
the value of the control item in the current job is a value selected by a user from the candidate.

### Aspect 20

The sheet embellishing method according to any one of Aspects 16 to 18, wherein
the predetermined processing is to set the value that is acquired to the value of the control item for the current job.

### Aspect 21

The sheet embellishing method according to any one of Aspects 16 to 20, wherein
the control item is a control item of the sheet embellishing system that affects a total light intensity of UV rays by which the varnish on the sheet is irradiated.

### Aspect 22

The sheet embellishing method according to any one of Aspects 16 to 21, wherein
the control item is UV emission intensity of UV rays emitted onto the sheet.

### Aspect 23

The sheet embellishing method according to aspect 22, wherein
the value that is acquired is a value of UV emission intensity to perform half-curing of the varnish on the sheet.

### Aspect 24

The sheet embellishing method according to Aspect 22, wherein
the value that is acquired is a value of UV emission intensity to perform full-curing of the varnish on the sheet.

### Aspect 25

The sheet embellishing method according to any one of Aspects 16 to 24, wherein
the control item is conveying speed of the sheet passing through an irradiation range of the UV rays.

### Aspect 26

The sheet embellishing method according to any one of Aspects 16 to 25, wherein
the transfer material exhibits adhesion force by being heated,
the transfer material is heated during the transferring in the execution of the current job, and
the control item is a heating temperature by the heating unit.

### Aspect 27

The sheet embellishing method according to any one of Aspects 16 to 26, wherein
the transferring is to convey a transfer web bearing the transfer material by roll-to-roll, and in conjunction therewith transfer the transfer material from the transfer web onto the varnish, wherein
the transfer material exhibits adhesion force by being heated,
the transfer material is heated during the transferring in the execution of the current job, and
the control item is a conveying speed of the transfer web.

### Aspect 28

The sheet embellishing method according to any one of Aspects 16 to 27, wherein
in a case in which the current job is executed in the fourth step, the value set to the control item is stored in the storage unit.

### Aspect 29

The sheet embellishing method according to any one of Aspects 16 to 28, wherein
adhesivity-related information for the current job is accepted from a user in the first step.

### Aspect 30

The sheet embellishing method according to any one of Aspects 16 to 29, wherein
a server that is externally situated is equipped with the storage unit, and
the storage unit that the external server is equipped with is referenced, and a value of the control item, of which the adhesivity-related information corresponds to the adhesivity-related information of the current job, is acquired from the storage unit of the external server via a network in the second step.

What is claimed is:

1. A sheet embellishing system that performs embellishment on a sheet while conveying the sheet, the sheet embellishing system comprising:
a varnish-applying unit that applies varnish having ultraviolet (UV) curability onto the sheet;
a UV irradiation unit that irradiates the varnish on the sheet by UV rays; and
a control device, wherein
the control device acquires, from a storage unit that stores adhesivity-related information that is information relating to adhesivity between the varnish on the sheet and a transfer material that is to be transferred into the varnish on the sheet, and a value regarding a control item of the sheet embellishing system, in a correlated manner, a value of the control item of which the adhesivity-related information corresponds to the adhesivity-related information of a current job, and executes predetermined processing using the value of the control item that is acquired.

2. The sheet embellishing system according to claim 1, wherein
the adhesivity-related information is information relating to the varnish on the sheet.

3. The sheet embellishing system according to claim 1, wherein
the adhesivity-related information includes at least one of type of the varnish on the sheet, thickness of the varnish on the sheet, color of a region on the sheet in which the varnish is to be applied, and type of foil in a case in which foil is to be transferred onto the varnish on the sheet.

4. The sheet embellishing system according to claim 1, wherein
the predetermined processing is to display the value that is acquired on a predetermined display unit as a candidate for the value of the control item.

5. The sheet embellishing system according to claim 1, wherein
the predetermined processing is to set the value that is acquired to the value of the control item for the current job.

6. The sheet embellishing system according to claim 1, wherein
the control item is a control item of the sheet embellishing system that affects a total light intensity of UV rays by which the varnish on the sheet is irradiated.

7. The sheet embellishing system according to claim 1, wherein
the control item is UV emission intensity of UV rays emitted by the UV irradiation unit.

8. The sheet embellishing system according to claim 7, wherein
the value that is acquired is a value of UV emission intensity for the UV irradiation unit to perform half-curing of the varnish on the sheet.

9. The sheet embellishing system according to claim 7, wherein
the value that is acquired is a value of UV emission intensity for the UV irradiation unit to perform full-curing of the varnish on the sheet.

10. The sheet embellishing system according to claim 1, wherein
the control item is conveying speed of the sheet passing through an irradiation range of the UV irradiation unit.

11. The sheet embellishing system according to claim 1, further comprising:
a transfer device that conveys a transfer web bearing the transfer material by roll-to-roll, brings the transfer web into contact with the varnish on the sheet, and transfers the transfer material from the transfer web, wherein
the transfer material exhibits adhesion force by being heated,
the transfer device includes a heating unit for heating the transfer material, and
the control item is a heating temperature by the heating unit.

12. The sheet embellishing system according to claim 1, further comprising:
a transfer device that conveys a transfer web bearing the transfer material by roll-to-roll, brings the transfer web into contact with the varnish on the sheet, and transfers the transfer material from the transfer web, wherein
the transfer material exhibits adhesion force by being heated,
the transfer device includes a heating unit for heating the transfer material, and
the control item is a conveying speed of the transfer web.

13. The sheet embellishing system according to claim 1, wherein
in a case in which a job is executed, the control device stores the value set to the control item in the storage unit.

14. The sheet embellishing system according to claim 1, wherein
the control device accepts adhesivity-related information for the current job from a user.

15. The sheet embellishing system according to claim 1, wherein
a server that is externally situated is equipped with the storage unit, and
the control device acquires a value of the control item, of which the adhesivity-related information corresponds to the adhesivity-related information of the current job, from the storage unit of the server via a network.

16. A sheet embellishing method, comprising:
a first step of acquiring adhesivity-related information that is information relating to adhesivity between varnish applied onto a sheet and a transfer material that is to be transferred onto the varnish on the sheet, regarding a current job;
a second step of referencing a storage unit that stores the adhesivity-related information in past jobs, and a value regarding a control item of a sheet embellishing system, in advance in a correlated manner, identifying at least one history information of a past job that has the adhesivity-related information corresponding to the adhesivity-related information of the current job, and acquiring a value regarding the control item in the past job that is identified;
a third step of executing predetermined processing using the value of the control item that is acquired, and setting the value of the control item in the current job; and
a fourth step of executing the current job by the value of the control item in the current job that is set, wherein
the sheet is embellished by irradiating and curing, by UV rays, UV curable varnish that is applied onto the sheet, while conveying the sheet, and also transferring the transfer material onto the varnish, by executing the current job.

17. The sheet embellishing method according to claim 16, wherein
the adhesivity-related information includes at least one of type of the varnish on the sheet, thickness of the varnish on the sheet, color of a region on the sheet in which the varnish is to be applied, and type of foil in a case in which foil is to be transferred onto the varnish on the sheet.

18. The sheet embellishing method according to claim 16, wherein
the predetermined processing is to display the value that is acquired on a predetermined display unit as a candidate for the value of the control item, and
the value of the control item in the current job is a value selected by a user from the candidate.

19. The sheet embellishing method according to claim 16, wherein
the predetermined processing is to set the value that is acquired to the value of the control item for the current job.

20. The sheet embellishing method according to claim 16, wherein
in a case in which the current job is executed in the fourth step, the value set to the control item is stored in the storage unit.
